(19) United States
(12) Patent Application Publication
(10) Pub. No.: US 2009/0267562 A1
(43) Pub. Date: Oct. 29, 2009

(54) PORTABLE BATTERY CHARGER FOR MULTIPLE ELECTRONIC DEVICES

(75) Inventors: Darren S. GUCCIONE, Wheaton, IL (US); Craig B. LUREY, El Dorado Hills, CA (US)

Correspondence Address: Levenfeld Pearlstein, LLC;Intellectual Property Department, 2 North LaSalle, Suite 1300, Chicago, IL, 60602, US

(73) Assignee: Callpod Inc., Chicago, IL (US)

(21) Appl. No.: 12/108,174

(22) Filed: Apr. 23, 2008

(51) Int. Cl. H02J 7/00

(52) U.S. Cl. 320/114

(57) ABSTRACT

The multiple unit portable battery charger disclosed is a portable, rechargeable refueling station for handheld and mobile electronics. The multiple device portable battery charger is capable of providing a full charge to two electronic devices either simultaneously or individually. Additionally, the battery charger can charge the two devices simultaneously up to three separate times before the battery charger requires recharging. In other words, the battery charger disclosed is capable of charging six or more devices before needing to be recharged itself.

### BACKGROUND OF THE INVENTION

The present invention is directed to a battery charger. More particularly, the present invention pertains to a battery charger which is portable, lightweight, is itself rechargeable, and able is to charge at least two electronic devices simultaneously.

Electronic handheld and mobile devices have permeated almost every aspect of people's lives today. Music is listened to on MP3 players, cell phones abound, and many people claim to have their lives programmed into their personal digital assistants (“PDAs”). Generally, people use a plethora of small portable devices including, but not limited to, cell phones, wireless headsets, PDAs, MP3 players, navigation units, digital cameras, digital readers and portable game systems. All of these devices run on rechargeable batteries. When the electronic device's battery is depleted of energy, the battery must be recharged. Recharging an electronic device battery is not particularly troublesome if the handheld and electronic device is near a wall outlet and the correct charger is readily available. The issue becomes obvious, however, when a wall outlet or the correct charger cannot be found, when the electronic device is in an area without access to a wall outlet, such as an airplane or train, or when the electronic device is in a foreign country that has a different electrical standard and where the associated battery chargers may not be adapted to work.

Portable battery chargers currently on the market for handheld and electronic devices are heavy, bulky and are limited in their capabilities. Current portable battery chargers typically can only charge one electronic device at a time and have no display which would indicate to a user when the battery charger itself needs to be charged. In addition, such chargers have buttons to press to begin charging a connected device, but no method to prevent the charger's battery from draining itself if the user forgets to turn the battery charger off.

Accordingly, there is a need for lightweight, portable, electronic device battery charger that is easy to use, conserves battery power, and is capable of charging multiple electronic devices simultaneously. Desirably, such a battery charger is itself rechargeable.

### BRIEF SUMMARY OF THE INVENTION

The multiple electronic device battery charger is a portable, rechargeable refueling station for handheld and mobile electronics. The multiple electronic device portable battery charger, hereafter “battery charger”, is capable of providing a full charge to two or more handheld or mobile devices, or other electronic devices, hereafter “electronic device(s)”, simultaneously or individually. Additionally, the battery charger can charge the two electronic devices simultaneously up to three separate times before the battery charger requires recharging. In other words, the battery charger disclosed is capable of charging six or more devices before needing to be recharged itself.

The battery charger has a housing, a lithium ion battery located within the housing and at least three interface ports, preferably mini-USB ports, on the housing. A first interface port is configured to enable charging of the lithium ion battery within the battery charger. The second and third interface ports are configured as output ports to receive electronic device charging adapters which are configured to enable charging of a plurality of electronic devices from the battery charger simultaneously. A fastening mechanism may also be present secure the charging adapters to the battery charger.

The battery charger contains a sense circuit which activates charging of the electronic device and deactivates charging of the electronic device, in part by sensing the presence or absence of the connection of an electronic device to the battery charger. The battery charger also includes a power level indicator to indicate the amount of power remaining in the battery charger's battery and an indicator to indicate the charging of an electronic device. The battery charger is configured with a voltage regulator circuit and with short circuit and reverse bias protection. A battery controller is present to protect the battery against battery depletion and discharge. In addition, an electronic device being charged is capable of operating while connected to the battery charger.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a plan view of an embodiment of the portable multi-device battery charger having two adapters attached;

FIG. 2 is a plan view of an embodiment of the portable multi-device battery charger having an adapter attached for charging the portable charger;

FIG. 3 is a front view of the portable battery charger two output charging ports;

FIG. 4 is a rear view of the portable battery charger input charging port;

FIG. 5 is a schematic block diagram of an embodiment of the portable battery charger.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description of the Invention”, relates to a requirement of the United States Patent Office, and does not imply, nor should be inferred to limit the subject matter disclosed herein.

The present battery charger is a portable, rechargeable refueling station for handheld and mobile electronics. The battery charger is capable of providing a full charge to multiple electronic devices simultaneously or individually. Additionally, the battery charger can charge multiple devices simultaneously up to three separate times before the battery charger requires recharging. In other words, the battery charger is capable of providing charging to six or more devices before needing to be recharged itself.

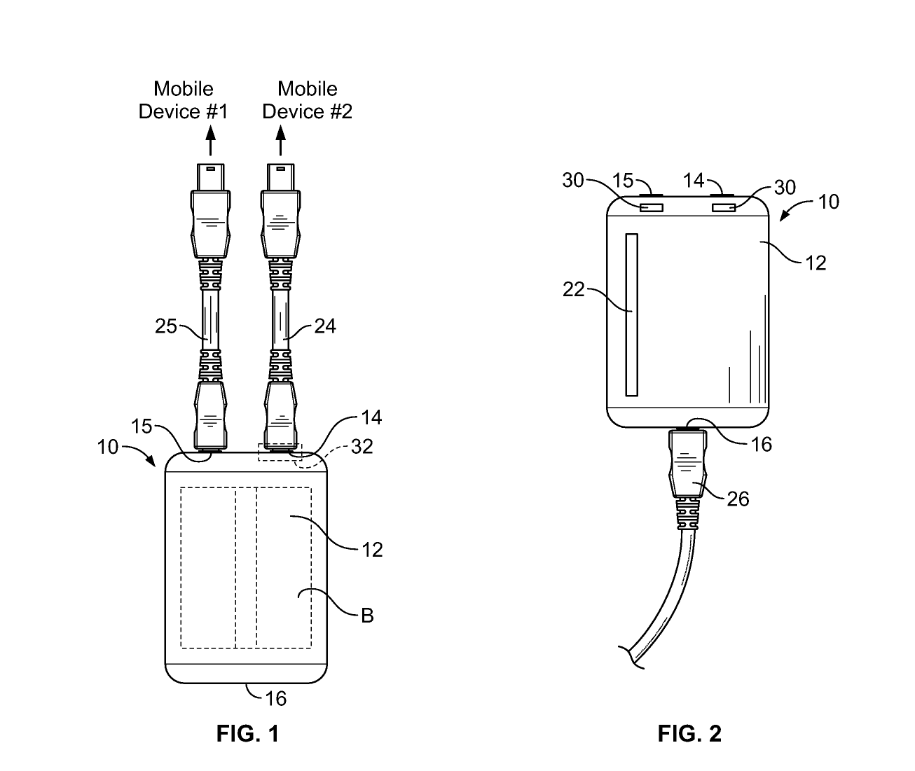

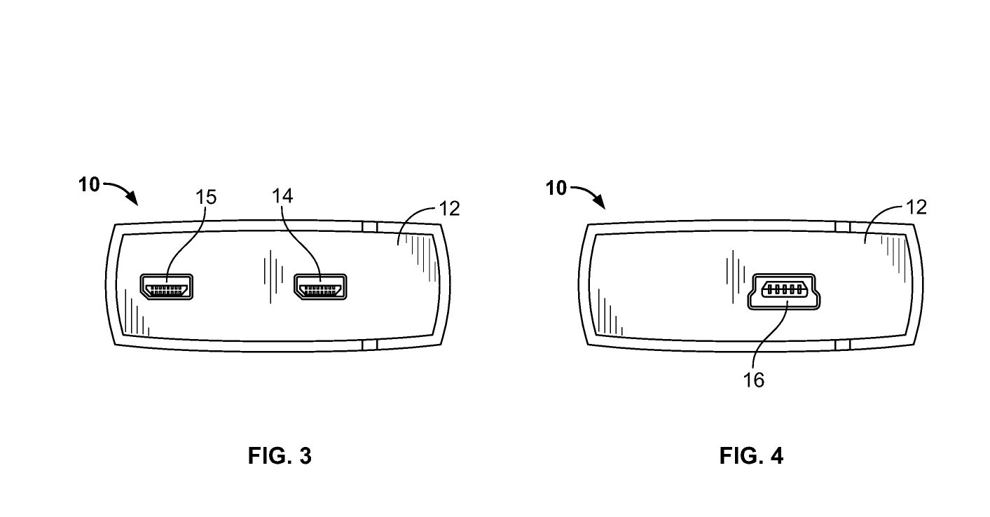

Referring now to the figures and in particular to FIGS. 1 and 2, there is shown an embodiment of the present battery charger. The battery charger 10 has a housing 12 having a lithium ion battery B located within the housing 12. The housing 12 has at least three interface ports 14, 15, and 16. Interface port 16 is configured as a mini-USB port 16. In a present embodiment, interface port 16 is configured as a five (5) pin USB port. Connected to interface port 16 is a USB compatible wall plug 26 or other mini-USB compatible adapter. Interface ports 14, 15 are also configured as mini-USB ports 14, 15. In a present embodiment, ports 14, 15 are configured as eight (8) pin mini-USB ports. While the present invention uses a mini-USB port for the purposes of illustration, it is understood and those in the art will appreciate that any electronic interface port or receptacles for connectors or connecting devices, now known or yet to be known, can be used with the present invention. All such output and input interface ports are intended to be within the scope of the present invention. Connected to interface ports 14, 15 are two charging adapters 24, 25. A battery level indicator 22 and a sense circuit indicator panel, for example, or light 30 are located on the housing 12.

In the present embodiment, the battery charger 10 is equipped with interface port 16 which is used for charging the lithium ion battery B located inside the housing 12. The interface port 16 illustrated is a 5-pin mini-USB connection and can receive wall plug adapters, car adapters, or other mini-USB compatible adapters, such as the CHARGEPOD® adapter. The adapter 26 is configured to connect to any 100 to 240 V_{AC} line or from a vehicle charger using standard 12 V_{DC}. Multiple wall plug adapter configurations for international coverage are also contemplated for use with the battery charger 10.

The battery charger 10 is also equipped with two interface ports 14, 15, in a present embodiment configured as female 8-pin mini-USB ports. The interface ports 14, 15 will connect with electronic device charging adapters 24, 25. The adapters 24, 25 are configured to operate with the specific product(s) or electronic device(s) which are to be charged. Adapter 24 may be used to operate with the same or different electronic devices as adapter 25. For example, adapter 24 may be used to charge a cellular phone while adapter 25 is used to charge MP3 players. To secure the adapters 24, 25 in the ports 14, 15 of the battery charger 10 during use, the battery charger 10 may be configured with a fastening mechanism 32 to secure the adapters 24, 25 in place and prevent unintentional removal of the adapters from the battery charger 10. A fastening mechanism may also be used to secure the electronic devices directly to the battery charger 10.

Regardless of the electronic devices being charged, the present battery charger 10 is capable of charging at least two electronic devices simultaneously. In addition, the dual ports 14, 15 also allow for electronic devices to be independently charged; in other words, one port may remain unconnected to an electronic device while the other port charges an individual electronic device. The battery charger 10 is capable of fully charging up to six electronic devices before the battery charger 10 requires recharging.

The battery charger 10 may be configured to use CHARGEPOD® proprietary adapters for use with the battery charger 10, and therefore, can be used to charge over 5,000 different devices including, but not limited to, wireless/cellular phones, PDAs, MP3 players, smartphones, portable navigation units, electronic/digital readers, digital cameras, and wireless headsets. The present battery charger 10 is not limited to handheld or mobile electronic devices; any compatible USB device with similar power ratings can be charged with the battery charger 10. In addition, it is also contemplated that the present battery charger 10 may be used without charging adapters and may connect directly to electronic connecting devices including, but not limited to, wireless/cellular phones, PDAs, MP3 players, smartphones, portable navigation units, electronic/digital readers, digital cameras, and wireless headsets.

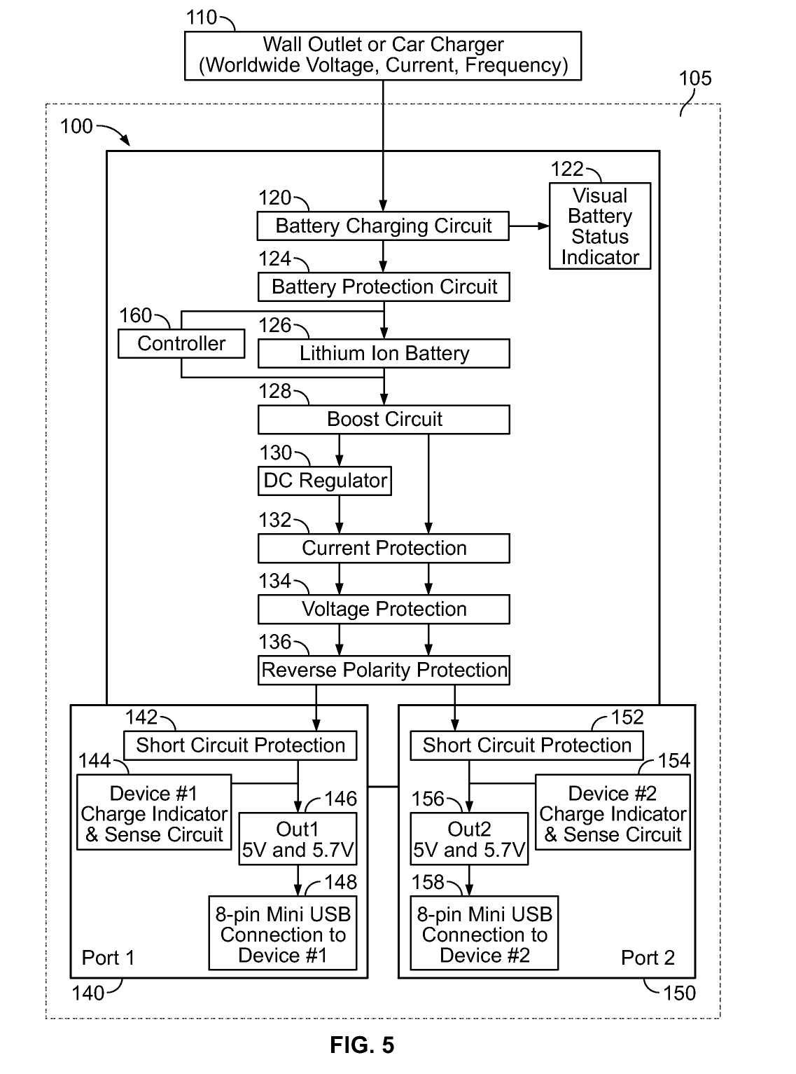

Turning now to FIG. 5, there is shown a block diagram of an embodiment of the present invention illustrating both the recharging circuit for the battery charger battery as well as the charging circuit for multiple electronic devices. Those skilled in the art will appreciate and understand that the following is an example of a circuit for the present battery charger, and that the following block diagram is not intended to limit the circuit configuration.

Battery charger 100 is shown in which the battery charger 100 may be recharged at a wall outlet or car charger, block 110. Adapters, as shown in FIG. 2 at 26, are used to connect the battery charger 100 to the wall outlet or car charger, block 110. The adapter(s) 26 of FIG. 2 are configured to account for various voltages, currents, and frequencies when charging the battery charger 100. Referring again to FIG. 5, there is integrated into the housing 105 of the battery charger 100 a power level indicator or visual battery status indicator, block 122. The visual battery status indicator, block 122 indicates the amount of power remaining in the battery charger 100 and to indicate when the battery charger 100 requires recharging. The battery charging circuit, block 120, has battery protection, block 124, including excess current and over voltage protection for the lithium ion battery during recharging of the battery, block 126. A battery controller, block 160, is present for protection of the internal lithium ion battery to protect against unintended battery depletion and discharge.

When the lithium ion battery is charged, the battery charger 100 can be used to charge multiple electronic devices. One or more electronic devices (not shown) may be connected to the battery charger 100 via adaptors (not shown) through ports 140, 150. Each port 140, 150 includes a mini-USB connection, blocks 148, 158. In the present embodiment, the ports 140, 150 include eight (8) pin mini USB connections. Each mini-USB connection, blocks 148, 158, are configured with a charge indicator or sense circuit, blocks 144, 154 to conserve power and thus, lengthen the usable life of the battery charger 100. The battery charger 100 utilizes the charge indicators or sense circuits, blocks 144, 154 to detect when a electronic device requiring power has been connected to the battery charger 100 at one or both of the mini-USB ports 148, 158. The charge indicator or sense circuit, blocks 144, 154 senses the presence of an electronic device requiring charging and activates a charging cycle.

The connection of the electronic device to the mini-USB port signals the battery charger to charge the electronic device. Charging of the electronic device's battery requires discharging of the lithium ion battery. The voltage discharge from the lithium ion battery is boosted, block 128, and regulated via a DC regulator, block 130.

The battery charger 100 also includes various protection circuits to protect the electronic device being charged from excess current or overvoltage discharge from the lithium ion battery. Such protection includes current protection, block 132, voltage protection, block 134, and reverse polarity protection, block 136. Each electronic device input port 140, 150 includes short circuit protection, block 142, 152. In addition, the charge indicator or sense circuit, blocks 144, 154 will deactivate the charging cycle when the charge indicator or sense circuit, blocks 144, 154, determine that the electronic device is fully charged or when the charge indicator or sense circuit, blocks 144, 154 senses that the electronic device has been removed. Thus, the charge indicator or sense circuit, blocks 144, 154 allow the battery charger 100 to conserve battery power—i.e. a user will not be able to waste the battery by forgetting to turn the power off or by overcharging the electronic device's battery. Charge indicator panels or lights on housing 105 indicate when the electronic device is being charged or has fully charged.

The battery charger is small and portable to fit in a shirt or pants pocket, brief case, and the like. In addition, the battery charger is configured such that the electronic device may be used while connected to the battery charger. For example, if a electronic device such as a cell phone is charging and it rings, a user may simply pick up the cell phone and the battery charger and answer the call. Thus, the present battery charger is lightweight, portable, electronic device battery charger that is easy to use, conserves battery power, and is capable of charging multiple electronic devices simultaneously.

All patents referred to herein, are incorporated herein by reference, whether or not specifically done so within the text of this disclosure. In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A portable electronic device battery charger, the battery charger comprising:
a housing;
a battery, the battery located within the housing;
at least three interface ports on the housing, wherein a first interface port is configured to enable charging of the battery and a second and a third interface port are configured to enable charging of a plurality of electronic devices from the battery simultaneously.

2. The battery charger of claim 1, wherein the battery is a lithium ion battery.

3. The battery charger of claim 1 wherein the second and third interface ports are configured to receive connecting devices.

4. The battery charger of claim 1, wherein the second and third interface ports are configured to receive electronic device charging adapters.

5. The batter charger of claim 4, wherein the electronic device charging adapters are configured for different electronic devices.

6. The battery charger of claim 1, wherein a sense circuit activates a charging of the electronic device.

7. The battery charger of claim 1, wherein a sense circuit deactivates charging of the electronic device.

8. The battery charger of claim 7, wherein the sense circuit senses the absence of the connection to the electronic device.

9. The battery charger of claim 1, further comprising a power level indicator.

10. The battery charger of claim 1, wherein an indicator indicates charging of an electronic device.

11. The battery charger of claim 1 further comprising a voltage regulator circuit.

12. The battery charger of claim 1 further comprising a circuit with short circuit protection.

13. The battery charger of claim 1 further comprising a circuit with reverse bias protection.

14. The battery charger of claim 1 further comprising a battery controller configured to protect the battery against battery depletion and discharge.

15. The battery charger of claim 3 further comprising a fastening mechanism to secure the connecting devices.

16. The battery charger of claim 4 further comprising a fastening mechanism to secure the charging adapters.

17. The battery charger of claim 1 wherein the electronic device being charged is capable of operating while connected to the battery charger.
